(19) United States
(12) Patent Application Publication
(10) Pub. No.: US 2020/0227186 A1
(43) Pub. Date: Jul. 16, 2020

(54) Ferromagnetic Alloy and Method of Manufacturing the Ferromagnetic Alloy

(71) Applicant: Hitachi, Ltd., Chiyoda-ku, Tokyo (JP)

(72) Inventor: Hiroyuki SUZUKI, Tokyo (JP)

(21) Appl. No.: 15/754,811

(22) PCT Filed: Aug. 26, 2015
(86) PCT No.: PCT/JP2015/073928

§ 371 Date: Feb. 23, 2018

(51) Int. Cl. H01F 1/055; C22C 38/00; C22C 33/04

(52) U.S. Cl. CPC H01F 1/055; C22C 38/005; C22C 2200/00; C22C 2202/02; C22C 33/04

(57) ABSTRACT

A Y—Fe ferromagnetic alloy formed by a rapid quenching process, in which a Fe element is not substituted partially or entirely by a structure stabilization element, has high magnetization, but still has a magnetic anisotropy that is too small for practical use. The present invention teaches that Gd is substituted partially for a binary system Y—Fe or a ternary system Y—Fe—Co as a main composition, thereby a magnetic anisotropic magnetic field can be increased, and Gd is substituted partially for a quaternary system Y—Sm—Fe—Co, thereby a magnetic anisotropic magnetic field does not vary or is reduced.

### TECHNICAL FIELD

The present application relates to a ferromagnetic alloy and a method of manufacturing the ferromagnetic alloy.

### BACKGROUND ART

Recently, a magnet having a reduced content of a rare earth element is desirably developed. The rare earth element in this description means at least one element selected from a group of scandium (Sc), yttrium (Y), and lanthanoid. The lanthanoid is a general name of 15 elements from lanthanum to lutetium.

### CITATION LIST

### Patent Literature

Patent Literature 1: Japanese Unexamined Patent Application Publication No. 2014-47366.

### SUMMARY OF INVENTION

### Technical Problem

RFe₁₂ (R is at least one rare earth element) having a body-centered tetragonal ThMn₁₂ crystal structure is known as a ferromagnetic alloy containing a relatively small compositional ratio of a rare earth element. However, the RFe₁₂ has a unique problem of the binary system, i.e., a thermally instable crystal structure. Patent Literature 1 teaches that Y is selected as R and a rapid quenching process is used, thereby a ThMn₁₂ type is formed in a Y—Fe binary system.

The ferromagnetic alloy of Patent Literature 1 has high magnetization because the Fe element is not substituted partially or entirely by a structure stabilization element M (M=Si, AI, Ti, V, Cr, Mn, Mo, W, Re, Be, Nb, and the like), but still has a magnetic anisotropy that is too small for practical use.

### Solution to Problem

To solve the above-described problem, a ferromagnetic alloy of the present invention includes an R′-TM ferromagnetic alloy that is one of a Y—Fe ferromagnetic alloy, a Y—Fe—Co ferromagnetic alloy, and a Y—Sm—Fe—Co ferromagnetic alloy, wherein the R′ is a rare earth element including at least elemental species Y and Gd, the TM is a transitional metal including at least an elemental species Fe, the ferromagnetic alloy has a main phase in which a rare earth element site occupied by the rare earth element is partially substituted by Gd, and the main phase has an intermediate crystal structure between a TbCu₇ crystal structure and a ThMn₁₂ crystal structure.

To solve the above-described problem, a method of manufacturing a ferromagnetic alloy of the present invention is provided, the ferromagnetic alloy including an R′-TM ferromagnetic alloy being one of a Y—Fe ferromagnetic alloy, a Y—Fe—Co ferromagnetic alloy, and a Y—Sm—Fe—Co ferromagnetic alloy, wherein the R′ is a rare earth element including at least elemental species Y and Gd, the TM is a transitional metal including at least an elemental species Fe, and the method includes: a step A of preparing a molten metal of an alloy containing the R′ and the TM; and a step B of cooling and solidifying the molten metal of the alloy to allow at least a part of a site occupied by the rare earth element to be randomly substituted by a Fe atom pair to form the R′-TM ferromagnetic alloy including an R′-TM ferromagnetic compound which is a ferromagnetic compound.

### ADVANTAGEOUS EFFECTS OF INVENTION

According to the present invention, it is possible to provide a new ferromagnetic alloy that solves the problem of the low magnetic anisotropic magnetic field, and a method of manufacturing the ferromagnetic alloy.

### BRIEF DESCRIPTION OF DRAWINGS

FIG. 1 schematically illustrates a crystal structure of an R′-TM ferromagnetic compound of the present invention.

FIG. 2 illustrates a correspondence relationship between the crystal structure of the R′-TM ferromagnetic compound of the present invention, a ThMn₁₂ crystal structure, and a TbCu₇ crystal structure.

FIG. 3 illustrates the crystal structure of the R′-TM ferromagnetic compound of the present invention, the ThMn₁₂ crystal structure, and the TbCu₇ crystal structure.

### DESCRIPTION OF EMBODIMENTS

### Composition, Structure, and Magnetic Anisotropic Magnetic Field of R′-TM Ferromagnetic Compound

The R′-TM ferromagnetic alloy of the present invention is an R′-TM ferromagnetic alloy including an R′-TM ferromagnetic compound in a space group Immm. In this description, “R′” represents a rare earth element that includes at least yttrium (Y) and gadolinium (Gd) and may further include Sm. In addition, “TM” represents a transition metal that includes Fe and may further include Co. However, “TM” has a composition in which an atomic ratio of Fe is larger than an atomic ratio of Co.

This R′-TM ferromagnetic compound is a ferromagnetic compound in which at least some of an occupied site (occupiable site) of the rare earth element in the body-centered tetragonal ThMn₁₂ crystal structure is randomly substituted by a pair of Fe atoms (Fe dumbbells). In other words, the R′-TM ferromagnetic compound has an intermediate crystal structure between the TbCu₇ crystal structure and the ThMn₁₂ crystal structure. Although the Fe dumbbells are naturally included in TM, since a Co atom does not coordinate with a Fe dumbbell site in the compositional range of the present invention, the Fe dumbbells are represented as Fe dumbbells.

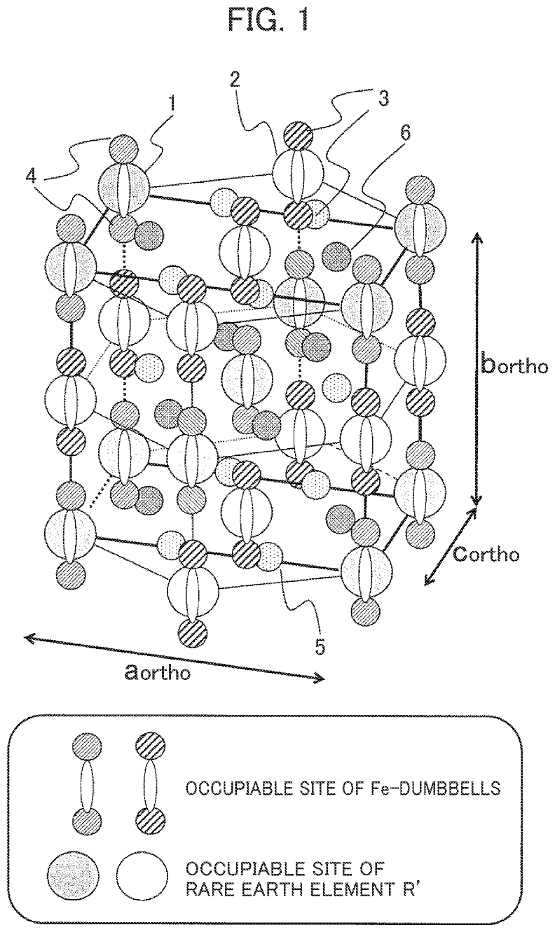

FIG. 1 schematically illustrates a crystal structure of an R′-TM ferromagnetic compound of the present invention. In FIG. 1, occupiable sites of the rare earth element R′, LRE, and the Fe dumbbells are depicted by a large circle and a mark of the Fe dumbbells in an overlapped manner. In detail, a 2a site (gray circle) and a 2d site (white circle) are shown as the occupied sites of the rare earth element R′.

A 4g₁ site and a 4g₂ site are shown as occupied sites of the Fe dumbbells. In the R′-TM ferromagnetic compound of the present invention, the Fe dumbbells may randomly occupy the occupied site of the rare earth element R′ in some degree.

In other words, in the crystal structure of the R′-TM ferromagnetic compound of the present invention, the Fe dumbbells are not completely randomly substituted for the rare earth element R′. The crystal structure in which the Fe dumbbells are completely randomly substituted for the rare earth element R′ is the TbCu₇ crystal structure. Hence, a superlattice diffraction, which shows development of regularity from the TbCu₇ crystal structure to the ThMn₁₂ crystal structure, is observed in an X-ray diffraction pattern of the R′-TM ferromagnetic compound.

However, the intensity of such a superlattice diffraction peak is weak compared with the intensity of a superlattice diffraction peak shown by the well-known ThMn₁₂ crystal structure, in which regularity is developed through substitution of the rare earth element by the Fe dumbbells. Specifically, diffraction peaks of (310) and (002) are appropriate indicia in that each peak has a high intensity and does not overlap with another peak. Such diffraction peaks, which are not observed in the TbCu₇ crystal structure, each have a weak intensity compared with that observed in the ThMn₁₂ crystal structure.

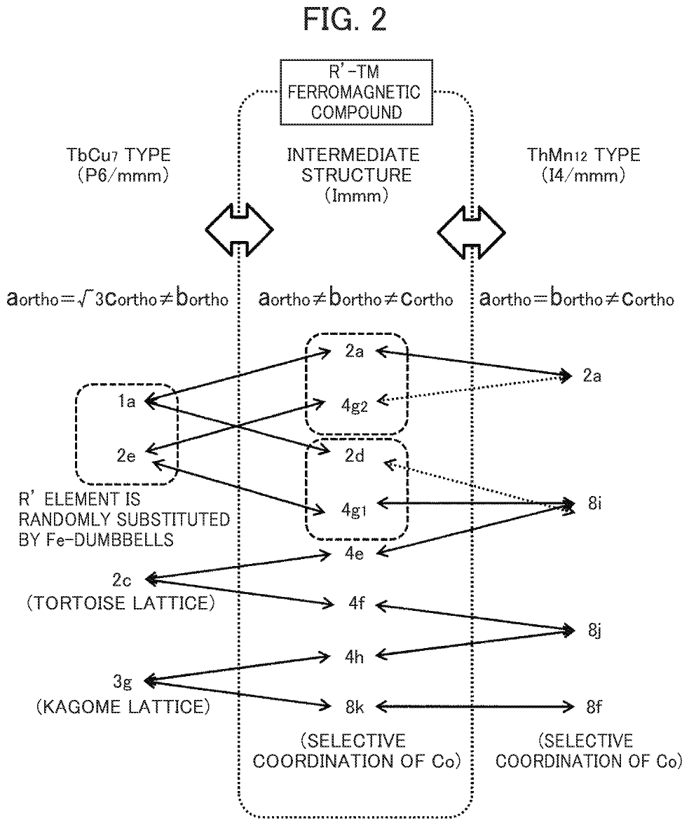

FIG. 2 illustrates a correspondence relationship showing that the crystal structure of the R′-TM ferromagnetic compound of the present invention is an intermediate structure between the ThMn₁₂ crystal structure and the TbCu₇ crystal structure. In the R′-TM ferromagnetic compound of the present invention, since the intermediate crystal structure between the TbCu₇ crystal structure and the ThMn₁₂ crystal structure is continuously formed through a heat treatment condition, the space group Immm is used to give the intermediate structure. The six-fold rotation symmetry around the c axis of the TbCu₇ type and the four-fold rotation symmetry around the c axis of the ThMn₁₂ type are eliminated and the body-centered symmetry remains, thereby the intermediate crystal structure can be given as continuous substitution of the rare earth element by the Fe dumbbells.

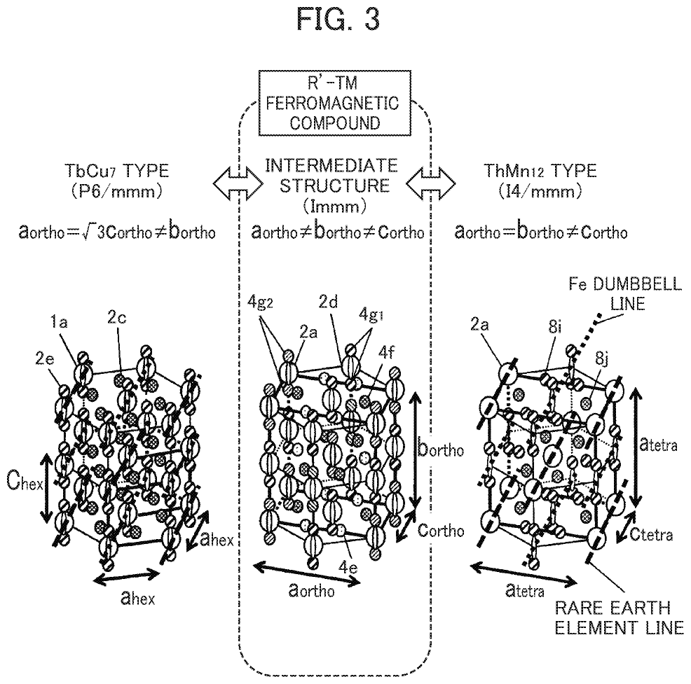

FIG. 3 schematically illustrates the crystal structure of the R′-TM ferromagnetic compound of the present invention, the ThMn₁₂ crystal structure, and the TbCu₇ crystal structure to show the relationships between such crystal structures. In the ThMn₁₂ crystal structure, the Fe dumbbells are located on a Fe dumbbell line in the occupied site of the rare earth element R′. In the TbCu₇ crystal structure, the Fe dumbbells are located at any position in the occupied site of the rare earth element R′.

In other words, in the TbCu₇ crystal structure, occupancy probability of the Fe dumbbells is not different between on the Fe dumbbell line and on the rare earth element line. In contrast, in the crystal structure of the R′-TM ferromagnetic compound of the present invention, the occupancy probability of the Fe dumbbells is not equal between on the Fe dumbbell line and on the rare earth element line. The crystal structure, which has such irregularity in a position of the Fe dumbbells and satisfies aₒᵣₜₕₒ=bₒᵣₜₕₒ in lattice constant, is referred to as “irregular ThMn₁₂ type”. While the prohibition of aₒᵣₜₕₒ≠bₒᵣₜₕₒ exists in the orthorhombic crystal, such prohibition is eliminated to represent a continuous change in crystal structure.

When the composition of the R′-TM ferromagnetic compound of the present invention is represented by Y₁₋ₐ₋ₓGdₐSmₓ (Fe_{1-y}CO_{y})_{z}, a compositional range of 10.5<z<14.0 is desirable. The reason for this is as follows. In a compositional range of 11.5≤z<14.0, an orthorhombic crystal (irregular ThMn₁₂ crystal structure), in which the a axis has the same length as the c axis, is finally formed. In a compositional range of 10.5<z<11.5, an orthorhombic crystal (quasi-irregular ThMn₁₂ crystal structure), in which only a slight difference, about 0.1% at the maximum, in length exists between the a axis and the c axis, is finally formed. Appropriate heat treatment is therefore performed appropriately for formation of such final structures. Furthermore, the R′-TM ferromagnetic compound is desirably within a composition range of 0≤x≤0.5, 0<y<0.5, and 0<α<1 (naturally 0<x+α<1).

While the magnetic anisotropic energy of the ferroelectric compound at room temperature is varied according to the substitution amount of Sm, such an increase or decrease in the magnetic anisotropic energy varies complicatedly according to the substitution amount of Gd as described later. When the substitution amount of Sm is too large, i.e., x>0.5, the main phase is not formed in a sufficient amount for practical use. Partial substitution of Co is preferable in light of an increase in magnetization and in magnetic anisotropy at room temperature due to an increase in Curie temperature. However, an extremely large amount of substitution of Co undesirably leads to a reduction in magnetization and in magnetic anisotropy.

Finally, a ratio between the rare earth element and the transitional metal is desirably a ratio allowing the main phase to be formed in an amount sufficient for practical use. In light of magnetic characteristics, a compositional range of 0≤x≤0.5, 0.1≤y≤0.3, and 10.5<z<14.0 is more desirable.

The inventors have focused on the fact that, as with Y, Gd can form a ThMn₁₂ intermetallic compound by the rapid quenching process without a structure stabilization element, and is bonded to a TM element in an antiferromagnetic manner. As the substitution amount of Gd increases, the magnetic anisotropic magnetic field increases while magnetization tends to be reduced.

However, when Sm is contained, it is estimated that Gd and Sm selectively and competitively coordinate with the rare earth element site responsible for magnetic anisotropy; hence, behavior of the magnetic anisotropic magnetic field is complicated. In light of the magnetic anisotropic magnetic field, therefore, for the Y—Fe ferromagnetic compound and the Y—Fe—Co ferromagnetic compound, i.e., in the case of x=0, α<1, at which Gd is substituted for Y as much as possible, is preferable, and α≥0.4 is more preferable. For the Y—Sm—Fe—Co ferromagnetic compound, i.e., in the case of 0<x≤0.5, behavior of the magnetic anisotropic magnetic field is complicated. For example, in the case of x=0. 4, α<1 is preferable in z≥11.5, and Gd is preferably not contained in z<11.5.

Hereinafter, an example of an embodiment of a method of manufacturing the R′-TM ferromagnetic alloy of the present invention is described for each step. It is beforehand described that while Patent Literature 1 has been listed as a patent literature related to this application, the content of the patent literature can be appropriately incorporated for description of this application.

### Method of Fabricating R′-TM Ferromagnetic Alloy

### (A) Step of Fabricating R′-TM Master Alloy

An alloy including R′ and TM is mixed and melted in a vacuum or an inert gas to produce a master alloy, so that a molten metal of the master alloy is prepared. The alloy composition is made uniform by the melting. An R′-TM alloy, which is beforehand produced and has a known composition, is used, thereby the alloy composition is advantageously easily controlled during metal melting by a rapid solidification process. Deviation from stoichiometry of the produced R′-TM master alloy ingot can be corrected in a step (B) described later. In another possible method, a plurality of alloys having different compositions are separately produced, and are mixed in the step (B) described later.

Composition analysis of the R′-TM master alloy ingot can be performed by inductively coupled plasma optical emission spectrometry (ICP-OES), for example. The deviation from stoichiometry can be suppressed by reducing the temperature rise time for melting, or adding a metal piece of the rare earth element later. In particular, when R contains Sm, since Sm easily evaporates because of its high vapor pressure, Sm is effectively added later.

A reduction diffusion process, in which an oxide or a metal of a compositional element is mixed with granular metal calcium for pyrogenetic reaction in an inert gas atmosphere, may be used in place of the above-described method. Since this process proceeds without a peritectic reaction, generation of a soft magnetic Fe (—Co) phase can be advantageously suppressed.

### (B) Step of Quench-Solidifying Master Alloy

In this embodiment, the R′-TM master alloy prepared in a form of the molten metal as described above is rapidly-solidified to produce a rapidly-solidified alloy. Examples of the rapid solidification process include a gas atomization process, and a roll quenching process such as a single roll quenching process, a double roll quenching process, a strip casting process, and a melt spinning process. Since rare-earth iron alloys tend to be oxidized, the quenching from high temperature is preferably performed in a vacuum or in an inert atmosphere.

R′₂TM₁₇, which is a compound phase of an irregular Th₂Ni₁₇ type, has a higher thermal stability than the R′-TM ferromagnetic compound of the present invention, and is thus not changed into the R′-TM ferromagnetic compound of the present invention and maintains the irregular RY₂TM₁₇ even after a heat treatment step (C) to be described later. Formation of the irregular RY₂TM₁₇ is therefore preferably suppressed during rapid solidification in that a certain production of the R′-TM ferromagnetic compound of the present invention is provided. This can be achieved by increasing the cooling rate.

In the case of using the melt spinning process with an air-cooling roll, roll circumferential speed is preferably set to equal to or higher than a certain speed in one embodiment. In the roll circumferential speed of equal to or higher than the certain speed, the R′-TM ferromagnetic compound is formed at the rate of 50 wt % or more. Further increasing the roll circumferential speed can suppress formation of the compound phase of the irregular Th₂Ni₁₇ type, leading to an increase in production of the R′-TM ferromagnetic compound of the present invention.

On the other hand, the structure of the R′-TM ferromagnetic compound of the present invention is changed and thermally decomposed according to a heat treatment temperature of the heat treatment step (C) to be described later. Hence, even if the roll circumferential speed is higher, the production of the R′-TM ferromagnetic compound of the present invention is not changed depending on the heat treatment temperature of the heat treatment step (C). Consequently, the upper limit of the roll circumferential speed is preferably determined in light of productivity.

In another embodiment of the present invention, the R′-TM ferromagnetic alloy can also be formed by a non-equilibrium process forming a metastable phase other than the rapid solidification process. Examples include a nanoparticle process and a thin-film process. The process specifically includes a gas phase process such as a molecular beam epitaxy process, a sputter process, an EB evaporation process, a reactive evaporation process, a laser aberration process, and a resistance heating evaporation process, a liquid phase process such as a microwave heating process, and a mechanical alloy process.

### (C) Heat Treatment Step

The crystal structure of the R′-TM ferromagnetic compound of the present invention is continuously changed by the heat treatment from the TbCu₇ crystal structure, in which the rare earth element is completely randomly substituted by the dumbbell-type Fe atom pairs, to the ThMn₁₂ crystal structure, in which the rare earth element is regularly substituted by the dumbbell-type Fe atom pairs. Therefore, the heat treatment temperature and the heat treatment time are important in light of controlling the crystal structure of the R′-TM ferromagnetic compound. Large magnetic anisotropic energy can be provided through progress of the regularization into the ThMn₁₂ crystal structure.

Heat treatment is therefore performed in a preferred embodiment to optimize the structure of the R′-TM ferromagnetic alloy of the present invention or the R′-TM ferromagnetic compound of the present invention formed by the above-described method. If a sample is held for a long time in a high-temperature atmosphere, the rare earth element may evaporate, the sample maybe oxidized, and productivity may be reduced. Hence, the heat treatment step is desirably performed at a temperature allowing uniform heat treatment for a relatively short time. The heat treatment temperature may be set between 600 and 1000° C., for example. The heat treatment time may be set within a range from 0.01 to less than 10 hours, for example. The heat treatment atmosphere must be inert, and is desirably Ar atmosphere. When Sm is contained, since Sm may be lost from the sample because of its high vapor pressure, the heat treatment atmosphere is desirably Sm atmosphere.

Although high temperature is preferable in consideration of the regularization of the R′-TM ferromagnetic compound from the TbCu₇ crystal structure to the ThMn₁₂ crystal structure, since decomposition of the R′-TM ferromagnetic compound is not negligible, a heat treatment temperature, at which the R′-TM ferromagnetic compound is less likely to be decomposed, is more desirable. In the present invention, since the magnetic anisotropic magnetic field is evaluated by a singular point detection (SPD) method, the heat treatment was performed at a temperature in consideration of such matters. The SPD method cannot detect a singular point in the case of strong exchange coupling between nanocrystals. The heat treatment temperature was increased while a reduction in proportion of the main phase was allowed in some degree, thereby crystal grains were grown to a size that, however, did not allow the exchange coupling to be dominant.

### Description of Examples

Hereinafter, examples of the present invention are specifically, but not limitedly, described.

### Example 1 (Method of Fabricating Y—Gd—Fe Ferromagnetic Alloy)

### Step A

First, Y (purity: 99.9%) and electrolytic iron (purity: 99. 9%) were weighed to produce a raw alloy having a total weight of 1 kg and a composition of 7.7Y-92.3Fe (at %) (YFe₁₂ by chemical formula). In consideration of evaporation of Y at high temperature, 123.0 g of Y and 882.9 g of Fe were each weighed such that the amount of Y was larger by 5 mass % than the target composition 7.7Y-92.3Fe. The weighed metals were mixed and put into an alumina crucible, and melted by high-frequency melting. Subsequently, the molten metal was spread on a water-cooled copper hearth and thus solidified to produce an alloy ingot. The alloy ingot was analyzed using an inductively coupled plasma (ICP) analyzer. As a result, the composition of the alloy ingot was 7.7Y-92.3Fe (at %). Similarly, an alloy having a composition of 8.4Gd-91.6Fe (at %) was produced.

A metal piece of Y and a metal piece of Gd were added to such produced ingots having the compositions of 7.7Y-92.3Fe and 8.4Gd-91.6Fe while the ingots of 7.7Y-92.3Fe and 8.4Gd-91.6Fe and the metal pieces of Y and Gd were each weighed such that a total composition of, for example, Y_{0.4}Gd_{0.6}Fe₁₁ by chemical formula was obtained, and then the ingots and metal pieces were put into a tapping pipe. The tapping pipe, which was loaded with the ingots of 7.7Y-92.3Fe and 8.4Gd-91.6Fe and the metal pieces of Y and Gd, was introduced in a high-frequency induction heating furnace, and the ingots and the metal pieces were heated and melted in a 20 kPa Ar atmosphere by application of a high-frequency electric field. Samples were each fabricated in such a manner that an appropriate amount of each of metal pieces of Y and Gd was added to the ingots of 7.7Y-92.3Fe and 8.4Gd-91.6Fe in the same procedure as described above to adjust the total composition, and the samples were heated and melted. The composition of each sample was adjusted in a range of Y_{1-α}Gd_{α}Fe_{z} (0<α<1, z=11, 12) by chemical formula. Hereinafter, the alloy composition is represented by chemical formula in this example.

### Step B

After it was confirmed that the Y—Gd—Fe alloy was sufficiently melted in the step A, the molten metal was injected by Ar at a tapping pipe pressure of 48 kPa onto a roll rotating at high speed, and was thus rapidly solidified to produce a beltlike alloy (hereinafter, rapidly quenched ribbon). In this example, a first roll circumferential speed (high speed) was set as a basic condition. This is because increasing roll circumferential speed makes it possible to suppress formation of the irregular Th₂Ni₁₇ type in an as-spun sample (sample that is not heat-treated after rapid solidification) so that phase separation or structural change during a heat treatment process is easily traced. However, the rapidly quenched ribbon was also produced at a second roll circumferential speed (low speed) slower than the first roll circumferential speed in order to forma relatively large crystal grains to easily detect an anisotropic magnetic field by the SPD method.

Although the cooling rate of the molten alloy is expressed by “roll circumferential speed” in this description, since the roll circumferential speed may be varied depending on heat conductivity or heat capacitance of a roll used for cooling, atmospheric pressure, tapping pipe pressure, and the like, the cooling rate can also be controlled using such parameters.

### Step C

The rapidly quenched ribbon produced in the step B was wrapped in a Nb foil, and was loaded in a quartz tube with an inner atmosphere of Ar flow, and then the quartz tube was put into a tubular furnace beforehand set to a certain temperature, and was held for 0.3 to 0.5 hours. Subsequently, the quartz tube was dropped into water and sufficiently cooled. Heat treatment in the Ar flow atmosphere can suppress evaporation of the Y element and of the Gd element compared with heat treatment in a vacuum. In this example, therefore, the heat treatment was performed in the Ar flow atmosphere in order to suppress deviation from stoichiometry.

### Magnetic Anisotropic Magnetic Field

The rapidly quenched ribbon produced in the step C was pulverized to 75 μm or less and thus formed into fine powder. The fine powder and paraffin were packed in an acrylic container, and were heated to fabricate an evaluation sample fixed in a non-oriented manner. This sample was introduced into a superconductor electromagnet type of a vibrating sample magnetometer maintained at 20° C., and a maximum magnetic field of 5 T or 10 T was temporarily applied to the sample, and then the magnetic field was swept to 0 T to determine a magnetization curve. A position, at which the first order differential to the magnetic field of the magnetization curve had a peak, was defined to correspond to the magnetic anisotropic magnetic field, and peak extraction was performed in consideration of composition trend and a proportion of the main phase. Since the measurement sample had unclear bulk magnetization and an indefinite shape, demagnetization correction was not performed. Through powder X-ray diffraction measurement, diffraction peaks (310) and (002), which indicated development of the regularization of the R′ and Fe dumbbells into the ThMn₁₂ crystal structure, were observed with limited intensity.

TABLE 1

| | | Roll | Heat | Anisotropic |
|---|---|---|---|---|
| | | circumferential | treatment | magnetic |
| Sample | Composition | velocity (m/s) | time (min) | field (T) |
| Comparative | YFe₁₁ | High | 30 | 2.5 (±0.5) |
| example 1 | | | | |
| Sample 1 | Y_{0.8}Gd_{0.2}Fe₁₁ | High | 20 | 2.5 (±0.2) |
| Sample 2 | Y_{0.6}Gd_{0.4}F₁₁ | High | 20 | 2.5 (±0.2) |
| Sample 3 | Y_{0.4}Gd_{0.6}Fe₁₁ | High | 20 | 2.6 (±0.2) |
| Sample 4 | Y_{0.2}Gd_{0.8}Fe₁₁ | High | 20 | 2.8 (±0.4) |
| Comparative | GdFe₁₁ | High | 20 | 3.0 (±0.4) |
| example 2 | | | | |
| Comparative | YFe₁₂ | High | 30 | 2.2 (±0.2) |
| example 3 | | | | |
| Sample 5 | Y_{0.8}Gd_{0.2}Fe₁₂ | Low | 30 | 2.2 (±0.2) |
| Sample 6 | Y_{0.6}Gd_{0.4}Fe₁₂ | Low | 30 | 2.3 (±0.2) |

Table 1 shows a magnetic anisotropic magnetic field at 20° C. of a Y_{1-α}Gd_{α}Fe_{z} (0<α<1, z=11, 12) ferromagnetic compound. It was found that Gd substitution increased the magnetic anisotropic magnetic field and that, in particular, the magnetic anisotropic magnetic field was abruptly increased from around a compositional range of a substitution amount α≥0.4. The substitution range of α≥0.4 is thus more preferable in light of the magnetic anisotropic magnetic field at room temperature.

### Example 2 (Method of Fabricating Y—Gd—Fe—Co Ferromagnetic Alloy)

### Step A

First, Y (purity: 99.9%), electrolytic iron (purity: 99.9%), and electrolytic cobalt (purity: 99.9%) were weighed to produce a raw alloy having a total weight of 0.9 kg and a composition of 7.7Y-80.8Fe-11.5Co (at %) (Y(Fe_{0.87}Co_{0.13})₁₂ by chemical formula). In consideration of evaporation of Sm at high temperature, Y, Fe, and Co were each weighed such that the amount of Y was larger by 3 mass % than the target composition 7.7Y-80.8Fe-11.5Co. The weighed metals were mixed and put into an alumina crucible, and melted by high-frequency melting. Subsequently, the molten metal was spread on a water-cooled copper hearth and thus solidified to produce an alloy ingot. The alloy ingot was analyzed using an ICP analyzer. As a result, the composition of the alloy ingot was 7.4Y-8.13Fe-11.3Co (at %). Similarly, an alloy having a composition of 7.6Gd-81.0Fe-11.4Co (at %) was produced.

A metal piece of Y, a metal piece of Gd, and a metal piece of Co were added to such produced ingots having the compositions of 7.4Y-8.13Fe-11.3Co and 7.6Gd-81.0Fe-11.4Co while the ingots of 7.4Y-8.13Fe-11.3Co and 7.6Gd-81.0Fe-11.4Co and the metal pieces of Y, Gd, and Co were each weighed such that the total composition of, for example, Y_{0.4}Gd_{0.6}(Fe_{0.83}Co_{0.17})₁₁ by chemical formula was obtained, and then the weighed ingots and metal pieces were put into a tapping pipe. The tapping pipe, which was loaded with the ingots of 7.4Y-8.13Fe-11.3Co and 7.6Gd-81.0Fe-11.4Co and the metal pieces of Y, Gd, and Co, was introduced in a high-frequency induction heating furnace, and the ingots and the metal pieces were heated and melted in a 20 kPa Ar atmosphere by application of a high-frequency electric field. Samples were each fabricated in such a manner that an appropriate amount of each of metal pieces of Y, Gd, and Co was added to the ingots of 7.7Y-92.3Fe and 8.4Gd-91.6Fe in the same procedure as described above to adjust the total composition, and the samples were heated and melted. The composition of each sample was adjusted in a range of Y₁₋ₓGdₓ (Fe_{0.83}Co_{0.17})z (0<x<1, z=11, 12) by chemical formula. Hereinafter, the alloy composition is represented by chemical formula in this example.

### Step B

After it was confirmed that the Y—Gd—Fe—Co alloy was sufficiently melted in the step A, the molten metal was injected by Ar at a tapping pipe pressure of 48 kPa onto a roll rotating at high speed, and was thus rapidly solidified to produce a beltlike alloy (hereinafter, rapidly quenched ribbon). In this example, a first roll circumferential speed (high speed) was set as a basic condition. This is because increasing roll circumferential speed makes it possible to suppress formation of the irregular Th₂Ni₁₇ type in an as-spun sample (sample that is not heat-treated after rapid solidification) so that phase separation or structural change during a heat treatment process is easily traced. However, the rapidly quenched ribbon was also produced at a second roll circumferential speed slower than the first roll circumferential speed in order to form relatively large crystal grains to easily detect an anisotropic magnetic field by the SPD method.

Although the cooling rate of the molten alloy is expressed by “roll circumferential speed” in this description, since the roll circumferential speed may be varied depending on heat conductivity or heat capacitance of a roll used for cooling, atmospheric pressure, tapping pipe pressure, and the like, the cooling rate can also be controlled using such parameters.

### Step C

The rapidly quenched ribbon produced in the step B was wrapped in a Nb foil, and was loaded in a quartz tube with an inner atmosphere of Ar flow, and then the quartz tube was put into a tubular furnace beforehand set to a certain temperature, and was held for 0.3 to 0.5 hours. Subsequently, the quartz tube was dropped into water and sufficiently cooled. The heat treatment in the Ar flow atmosphere can suppress evaporation of the Y element and of the Gd element compared with heat treatment in a vacuum. In this example, therefore, the heat treatment was performed in the Ar flow atmosphere in order to suppress deviation from stoichiometry.

### Magnetic Anisotropic Magnetic Field

The rapidly quenched ribbon produced in the step C was pulverized to 75 μm or less and thus formed into fine powder. The fine powder and paraffin were packed in an acrylic container, and were heated to fabricate an evaluation sample fixed in a non-oriented manner. This sample was introduced into a superconductor electromagnet type of a vibrating sample magnetometer maintained at 20° C., and a maximum magnetic field of 5 T or 10 T was temporarily applied to the sample, and then the magnetic field was swept to 0 T to determine a magnetization curve. A position, at which the first order differential to the magnetic field of the magnetization curve had a peak, was defined to correspond to the magnetic anisotropic magnetic field, and peak extraction was performed in consideration of composition trend and a proportion of the main phase. Since the measurement sample had unclear bulk magnetization and an indefinite shape, demagnetization correction was not performed. Through powder X-ray diffraction measurement, diffraction peaks (310) and (002), which indicated development of the regularization of the R′ and Fe dumbbells into the ThMn₁₂ crystal structure, were observed with limited intensity.

TABLE 2

| | | Roll | Heat | |
|---|---|---|---|---|
| | | circum- | treat- | Aniso- |
| | | ferential | ment | tropic |
| | | velocity | time | magnetic |
| Sample | Composition | (m/s) | (min) | field (T) |
| Comparative | Y(Fe_{0.83}Co_{0.17})₁₁ | High | 30 | 2.6 (±0.2) |
| example 4 | | | | |
| Sample 7 | Y_{0.8}Gd_{0.2}(Fe_{0.83}Co_{0.17})₁₁ | Low | 20 | 2.5 (±0.2) |
| Sample 8 | Y_{0.6}Gd_{0.4}(Fe_{0.83}Co_{0.17})₁₁ | Low | 20 | 2.4 (±0.2) |
| Sample 9 | Y_{0.4}Gd_{0.6}(Fe_{0.83}Co_{0.17})₁₁ | Low | 20 | 3.1 (±0.2) |
| Sample 10 | Y_{0.2}Gd_{0.8}(Fe_{0.83}Co_{0.17})₁₁ | Low | 20 | 4.3 (±0.5) |
| Comparative | Y(Fe_{0.83}Co_{0.17})₁₁ | High | 30 | 2.8 (±0.2) |
| example 5 | | | | |
| Sample 11 | Y_{0.8}Gd_{0.2}(Fe_{0.83}Co_{0.17})₁₂ | Low | 20 | 2.6 (±0.2) |
| Sample 12 | Y_{0.6}Gd_{0.4}(Fe_{0.83}Co_{0.17})₁₂ | Low | 20 | 3.2 (±0.2) |
| Sample 13 | Y_{0.4}Gd_{0.6}(Fe_{0.83}Co_{0.17})₁₂ | Low | 20 | 4.3 (±0.2) |
| Sample 14 | Y_{0.2}Gd_{0.8}(Fe_{0.83}Co_{0.17})₁₂ | Low | 20 | 4.7 (±0.2) |

Table 2 shows a magnetic anisotropic magnetic field at 20° C. of a Y_{1-α}Gd_{α}(Fe_{0.83}Co_{0.17})_{z}(0<α<1, z=11, 12) ferromagnetic compound. It was found that Gd substitution increased the magnetic anisotropic magnetic field and that, in particular, the magnetic anisotropic magnetic field was abruptly increased from around a compositional range of a substitution amount α≥0.4. The substitution range of α≥0.4 is thus more preferable in light of the magnetic anisotropic magnetic field at room temperature.

### Example 3 (Method of Fabricating Y—Gd—Sm—Fe—Co Ferromagnetic Alloy)

### Step A

First, Sm (purity: 99.9%), electrolytic iron (purity: 99.9%), and electrolytic cobalt (purity: 99.9%) were weighed to produce a raw alloy having a total weight of 0.9 kg and a composition of 7.7Sm-80.8Fe-11.5Co (at %) (Sm(Fe_{0.87}Co_{0.13})₁₂) by chemical formula). In consideration of evaporation of Sm at high temperature, Sm, Fe, and Co were each weighed such that the amount of Sm was larger by 10 mass % than the target composition 7.7Sm-80.8Fe-11.5Co. The weighed metals were mixed and put into an alumina crucible, and melted by high-frequency melting. Subsequently, the molten metal was spread on a water-cooled copper hearth and thus solidified to produce an alloy ingot. The alloy ingot was analyzed using an ICP analyzer. As a result, the composition of the alloy ingot was 9.0Sm-78.1Fe-12.8Co (at %).

A metal piece of Y and a metal piece of Co were added to such a produced ingot having a composition of 9.0Sm-78.1Fe-12.8Co and the ingots having the compositions of 7.4Y-8.13Fe-11.3Co and 7.6Gd-81.0Fe-11.4Co produced in Example 2 while the ingots of 9.0Sm-78.1Fe-12.8Co, 7.4Y-8.13Fe-11.3Co, and 7.6Gd-81.0Fe-11.4Co and the metal pieces of Y and Co were each weighed such that the total composition of, for example, Y_{0.2}Gd_{0.4}Sm_{0.4}(Fe_{0.83}Co_{0.17})₁₁ by chemical formula was obtained, and then the weighed ingots and metal pieces were put into a tapping pipe. The tapping pipe, which was loaded with the ingots of 9.0Sm-78.1Fe-12.8Co, 7.4Y-81.3Fe-11.3Co, and 7.6Gd-81.0Fe-11.4Co and the metal pieces of Y and Co, was introduced in a high-frequency induction heating furnace, and the ingots and the metal pieces were heated and melted in a 20 kPa Ar atmosphere by application of a high-frequency electric field. Samples were each fabricated in such a manner that an appropriate amount of each of metal pieces of Y and Co was added to such ingots in the same procedure as described above to adjust the total composition, and the samples were heated and melted. The composition of each sample was adjusted in a range of Y_{0.6-α}Gd_{α}Sm_{0.4}(Fe_{0.83}Co_{0.17})_{z} (0<α<0.6, z=11, 12) by chemical formula. Hereinafter, the alloy composition is represented by chemical formula in this example.

### Step B

After it was confirmed that the Y—Gd—Sm—Fe—Co alloy was sufficiently melted in the step A, the molten metal was injected by Ar at a tapping pipe pressure of 48 kPa onto a roll rotating at high speed, and was thus rapidly solidified to produce a beltlike alloy (hereinafter, rapidly quenched ribbon). In this example, a first roll circumferential speed (low speed) was set as a basic condition. This is because relatively large crystal grains are intentionally formed to easily detect an anisotropic magnetic field by the SPD method. However, increasing roll circumferential speed makes it possible to suppress formation of the irregular Th₂Ni₁₇ type in an as-spun sample (sample that is not heat-treated after rapid solidification) so that phase separation or structural change during a heat treatment process is easily traced. Hence, the rapidly quenched ribbon was also produced at a second roll circumferential speed faster than the first roll circumferential speed.

Although the cooling rate of the molten alloy is expressed by “roll circumferential speed” in this description, since the roll circumferential speed may be varied depending on heat conductivity or heat capacitance of a roll used for cooling, atmospheric pressure, tapping pipe pressure, and the like, the cooling rate can also be controlled using such parameters.

### Step C

The rapidly quenched ribbon produced in the step B was wrapped in a Nb foil, and was loaded in a quartz tube with an inner atmosphere of Ar flow, and then the quartz tube was put into a tubular furnace beforehand set to a certain temperature, and was held for 0.3 to 0.5 hours. Subsequently, the quartz tube was dropped into water and sufficiently cooled. The heat treatment in the Ar flow atmosphere can suppress evaporation of the Y element and of the Gd element compared with heat treatment in a vacuum. In this example, therefore, the heat treatment was performed in the Ar flow atmosphere in order to suppress deviation from stoichiometry.

### Magnetic Anisotropic Magnetic Field

The rapidly quenched ribbon produced in the step C was pulverized to 75 μm or less and thus formed into fine powder. The fine powder and paraffin were packed in an acrylic container, and were heated to fabricate an evaluation sample fixed in a non-oriented manner. This sample was introduced into a superconductor electromagnet type of a vibrating sample magnetometer maintained at 20° C., and a maximum magnetic field of 10 T was temporarily applied to the sample, and then the magnetic field was swept to 0 T to determine a magnetization curve. A position, at which the first order differential to the magnetic field of the magnetization curve had a peak, was defined to correspond to the magnetic anisotropic magnetic field, and peak extraction was performed in consideration of composition trend and a proportion of the main phase. Since the measurement sample had unclear bulk magnetization and an indefinite shape, demagnetization correction was not performed. Through powder X-ray diffraction measurement, diffraction peaks (310) and (002), which indicated development of the regularization of the R′ and Fe dumbbells into the ThMn₁₂ crystal structure, were observed with limited intensity.

TABLE 3

| | | Roll | Heat | |
|---|---|---|---|---|
| | | circum- | treat- | Aniso- |
| | | ferential | ment | tropic |
| | | velocity | time | magnetic |
| Sample | Composition | (m/s) | (min) | field (T) |
| Comparative | Y_{0.6}Sm_{0.4}(Fe_{0.83}CO_{0.17})₁₁ | High | 30 | 7.6 (±0.5) |
| example 6 | | | | |
| Sample 15 | Y_{0.4}Gd_{0.2}Sm_{0.4}(Fe_{0.83}Co_{0.17})₁₁ | Low | 20 | 6.1 (±0.1) |
| Sample 16 | Y_{0.2}Gd_{0.4}Sm_{0.4}(Fe_{0.83}Co_{0.17})₁₁ | Low | 20 | 4.9 (±0.1) |
| Sample 17 | Y_{0.1}Gd_{0.5}Sm_{0.4}(Fe_{0.83}Co_{0.17})₁₁ | Low | 20 | 5 (±1) |
| Comparative | Y_{0.6}Sm_{0.4}(Fe_{0.83}CO_{0.17})₁₂ | High | 30 | 5.8 (±0.2) |
| example 7 | | | | |
| Sample 18 | Y_{0.5}Gd_{0.1}Sm_{0.4}(Fe_{0.83}Co_{0.17})₁₂ | Low | 20 | 5.2 (±0.2) |
| Sample 19 | Y_{0.4}Gd_{0.2}Sm_{0.4}(Fe_{0.83}Co_{0.17})₁₂ | Low | 20 | 5.2 (±0.2) |
| Sample 20 | Y_{0.3}Gd_{0.3}Sm_{0.4}(Fe_{0.83}Co_{0.17})₁₂ | Low | 20 | 5.3 (±0.2) |
| Sample 21 | Y_{0.2}Gd_{0.4}Sm_{0.4}(Fe_{0.83}Co_{0.17})₁₂ | Low | 20 | 4.8 (±0.2) |
| Sample 22 | Y_{0.1}Gd_{0.5}Sm_{0.4}(Fe_{0.83}Co_{0.17})₁₂ | Low | 20 | 5.3 (±0.2) |

Table 3 shows a magnetic anisotropic magnetic field at 20° C. of a Y_{0.6-α}Gd_{α}Sm_{0.4} (Fe_{0.83}Co_{0.17})_{z} (0<α<0.6, z=11, 12) ferromagnetic compound. It was found that the magnetic anisotropic magnetic field, which varies depending on the substitution amount of Gd, was reduced at a composition of z=11, and did substantially not vary or tended to be reduced at a composition of z=12. This is estimated to be due to site selectivity of each of Y, Sm, and Gd as the constitutional rare earth elements. The two crystallographic rare earth sites 2a and 2d exist, and the Y element strongly selectively coordinates with the 2a site, while the coordinated quantity of each of Sm and Gd varies depending on size of a space around each rare earth site corresponding to the substituted amount of the R′ by the Fe dumbbells.

It is estimated that when the Gd element is increasingly substituted in place of the Y element, Sm is expelled from the rare earth element site having a significant influence on the magnetic anisotropy, so that the magnetic anisotropy is reduced. Sm is an extremely important element that is responsible for most of the magnetic anisotropic magnetic field of the ferromagnetic compound of the present invention, and is preferably introduced as much as possible within a range in which production is not significantly reduced. In the case of x=0. 4, α<1 is preferable in z≥11.5, and Gd is preferably not contained in z<11.5.

The R′-TM ferromagnetic alloy of the present invention may be preferably used for a bulk magnet, for example. Devices using the ferromagnetic alloy of the present invention include a motor, a generator, and other drive units each having a drive component, and medical devices including MRI. When the ferromagnetic alloy is used in such devices, size is advantageously reduced. In addition, delay of supply or delay of manufacturing due to concerns about supply of the rare earth element can be prevented, and a price volatility risk of a completed device can also be reduced.

### LIST OF REFERENCE SIGNS

1: 2a site, 2: 2d site, 3: 4g₁ site, 4: 4g₂ site, 5: 4e site, 6: 4f site

1. A ferromagnetic alloy including an R′-TM ferromagnetic alloy that is one of a Y—Fe ferromagnetic alloy, a Y—Fe—Co ferromagnetic alloy, and a Y—Sm—Fe—Co ferromagnetic alloy,
wherein the R′ is a rare earth element including at least elemental species Y and Gd,
the TM is a transitional metal including at least an elemental species Fe,
the ferromagnetic alloy has a main phase in which a rare earth element site occupied by the rare earth element is partially substituted by Gd, and
the main phase has an intermediate crystal structure between a TbCu₇ crystal structure and a ThMn₁₂ crystal structure.

2. The ferromagnetic alloy according to claim 1,
wherein the intermediate crystal structure corresponds to an R′-TM ferromagnetic compound having the intermediate crystal structure between the TbCu₇ crystal structure in which a rare earth element is randomly substituted by a dumbbell-type Fe atom pair and the ThMn₁₂ crystal structure in which the rare earth element is regularly substituted by the dumbbell-type Fe atom pair.

3. The ferromagnetic alloy according to claim 2,
wherein the R′-TM ferromagnetic compound has a crystal structure in which diffraction peak intensity of each of (310) and (002) particularly has a limited value in a space group Immm in diffraction measurement.

4. The ferromagnetic alloy according to claim 1,
wherein the R′ further includes an elemental species Sm,
the TM further includes an elemental species Co and has a composition in which an atomic ratio of Fe is larger than an atomic ratio of Co, and
the ferromagnetic alloy is represented by a composition formula Y₁₋ₐ₋ₓGd_{α}Smₓ(Fe_{1-y}Co_{y})_{z}(0≤x≤0.5, 0≤y<0.5, 10.5<z<14.0, α>0).

5. The ferromagnetic alloy according to claim 1,
wherein the TM further includes an elemental species Co and has a composition in which an atomic ratio of Fe is larger than an atomic ratio of Co, and
the ferromagnetic alloy is represented by a composition formula Y_{1-α-x}Gd_{α}(Fe_{1-y}Co_{y})_{z}(0≤y<0.5, 10.5<z<14.0, 0<α<1).

6. The ferromagnetic alloy according to claim 5,
wherein the α is within a compositional range of 0.4≤α<1.

7. The ferromagnetic alloy according to claim 4,
wherein when the x satisfies 0<x<0.5, the z and the α are within compositional ranges of z≥11.5 and 0<α<1, respectively.

8. A method of manufacturing a ferromagnetic alloy, the ferromagnetic alloy being an R′-TM ferromagnetic alloy that is one of a Y—Fe ferromagnetic alloy, a Y—Fe—Co ferromagnetic alloy, and a Y—Sm—Fe—Co ferromagnetic alloy,
wherein the R′ is a rare earth element including at least elemental species Y and Gd, and the TM is a transitional metal including at least an elemental species Fe, the method comprising:
a step A of preparing a molten metal of an alloy containing the R′ and the TM; and
a step B of cooling and solidifying the molten metal of the alloy to allow at least a part of a site occupied by the rare earth element to be randomly substituted by a Fe atom pair to form the R′-TM ferromagnetic alloy including an R′-TM ferromagnetic compound.

9. The method according to claim 8, further comprising, after the step B, a heat treatment step heating the R′-TM ferromagnetic alloy.

10. The method according to claim 8,
wherein the R′-TM ferromagnetic alloy has an intermediate crystal structure between a hexagonal TbCu₇ crystal structure and a body-centered tetragonal ThMn₁₂ crystal structure.
